(19) United States
(12) Patent Application Publication
(10) Pub. No.: US 2021/0056491 A1
(43) Pub. Date: Feb. 25, 2021

(54) INFORMATION PROCESSING APPARATUS, INFORMATION PROCESSING METHOD, AND PROGRAM THEREFOR

(71) Applicant: SONY CORPORATION, TOKYO (JP)

(72) Inventors: MARI SAITO, KANAGAWA (JP); JURI YAEDA, TOKYO (JP); MITSUHIRO MIYAZAKI, KANAGAWA (JP); REIKO KIRIHARA, TOKYO (JP)

(21) Appl. No.: 16/960,312

(22) PCT Filed: Dec. 19, 2018
(86) PCT No.: PCT/JP2018/046783

§ 371 Date: Jul. 6, 2020

(30) Foreign Application Priority Data
Mar. 13, 2018 (JP) 2018-044926

(51) Int. Cl. G06Q 10/06

(52) U.S. Cl. CPC G06Q 10/063114; G06Q 10/06316; G06Q 10/063116

(57) ABSTRACT

[Object] To provide highly convenient information processing apparatus and information processing method and a program therefor. [Solving Means] An information processing apparatus includes an analysis unit and a notification information generating unit. The analysis unit is configured to analyze, on the basis of information about a plurality of performers capable of performing a habitual action in habitual information including descriptions of habitual actions of a plurality of users, whether at least one performer of the plurality of performers exists in a range in which the at least one performer is capable of performing the habitual action. The notification information generating unit is configured to generate, in a case where the analysis unit determines that the at least one performer exists in the range in which the at least one performer is capable of performing the habitual action, notification information addressed to the performer, the existence of which is determined, on the basis of the habitual information.

### TECHNICAL FIELD

The present technology relates to an information processing apparatus and an information processing method used for a personal assistant technology and to a program therefor.

### BACKGROUND ART

Patent Literature 1 has a disclosed a method of accurately detecting an abnormality of a user on the basis of a usual action habitude. Specifically, in a method of reproducing distributed content, an abnormality detector obtains audiovisual information (information related to a user's operation, information related to the content) at the current time and compares the audiovisual information at the current time with habitual information and preference information. If the abnormality detector detects an abnormality, the abnormality detector informs of the abnormality through a communication line (e.g., see paragraphs [0077] and [0078] in specification, FIGS. 4 and 5, and the like).

### CITATION LIST

### Patent Literature

Patent Literature 1: Japanese Patent Application Laid-open No. 2011-165134

### DISCLOSURE OF INVENTION

### Technical Problem

Technologies that make use of artificial intelligence (AI) are expected to increase more and more in the future. Along with this, it will be important to further develop and improve personal assistant technologies like the technology of Patent Literature 1 above.

It is an object of the present disclosure to provide highly convenient information processing apparatus and information processing method in a personal assistant technology and a program therefor.

### Solution to Problem

In order to accomplish the above-mentioned object, an information processing apparatus according to an embodiment includes an analysis unit and a notification information generating unit.

The analysis unit is configured to analyze, on the basis of information about a plurality of performers capable of performing a habitual action in habitual information including descriptions of habitual actions of a plurality of users, whether at least one performer of the plurality of performers exists in a range in which the at least one performer is capable of performing the habitual action.

The notification information generating unit is configured to generate, in a case where the analysis unit determines that the at least one performer exists in the range in which the at least one performer is capable of performing the habitual action, notification information addressed to the performer, the existence of which is determined, on the basis of the habitual information.

In a case where that this information processing apparatus determines that the performer does not exist as a result of processing by the analysis unit, a performing unit is capable of generating notification information regarding the habitual action to another person that can be the performer. Thus, even if one performer cannot perform the habitual action, it is possible to request another performer to perform it. Therefore, the convenience is enhanced.

The notification information generating unit may be configured to generate the notification information on the basis of a timing at which the habitual action is scheduled to be performed, the timing being included in the habitual information. Accordingly, the information processing apparatus is capable of making a notification that prompts a target to perform the habitual action and is capable of preventing the performer from forgetting the habitual action on the basis of it.

The notification information generating unit may be configured to generate the notification information by setting at least one performer of the plurality of performers to be a target in a case where the analysis unit determines that at least one performer of the plurality of performers exists and a current time has passed the timing at which the habitual action is scheduled to be performed.

The notification information generating unit may be configured to generate the notification information by setting at least one performer of the plurality of performers to be a target in a case where the analysis unit determines that the at least one performer of the plurality of performers exists and a current time is in a predetermined time duration including a reference time as the timing at which the habitual action is scheduled to be performed.

The habitual information may include priorities respectively given to the plurality of performers.

The notification information generating unit may be configured to select a target of the notification in an order that depends on the priorities.

The notification information generating unit may be configured to generate the notification information so as to make notifications stepwisely. Accordingly, the notification mode increases and the user can receive a provided notification intuitive to the user for example.

The notification information generating unit may be configured to generate the notification information so as to stepwisely make notifications as the timing at which the habitual action is scheduled to be performed approaches, the timing being included in the habitual information.

The information processing apparatus may further include a management unit configured to manage information in which the plurality of performers, the timing at which the habitual actions are scheduled to be performed, and the descriptions of the habitual actions are associated with each other, as the habitual information.

The analysis unit may be configured to further analyze whether or not an action of the user is a habitual action corresponding to one of the descriptions of the habitual actions in the stored habitual information.

The management unit may be configured to manage information including the description of the action performed by the user a predetermined number of times as the habitual information, the predetermined number of times being two or more times. In accordance with such machine learning, the user can save the time and effort to voluntarily register the habitual action.

The analysis unit may be configured to determine whether or not it is the habitual action on the basis of a co-occurrence rate of a plurality of action elements. By making a determination based on the co-occurrence rate, the determination accuracy as to whether or not it is the habitual action is enhanced.

The analysis unit may be configured to determine that it is the habitual action in a case where the plurality of action elements is temporally continuous.

The notification information generating unit may be configured to generate, in a case where the analysis unit determines that a first performer of the plurality of performers does not exist in a range in which the first performer is capable of performing the habitual action, notification information including information about the first performer as notification information addressed to the second performer. Accordingly, the second performer can know who the first performer was.

The habitual information may include a degree of reliability indicating reliability of recognition of the habitual action. Accordingly, various notification modes depending on the degree of reliability can be provided.

An information processing method according to an embodiment includes analyzing, on the basis of information about a plurality of performers capable of performing a habitual action in habitual information including descriptions of habitual actions of a plurality of users, whether at least one performer of the plurality of performers exists in a range in which the at least one performer is capable of performing the habitual action.

In a case where the analysis unit determines that the at least one performer exists in the range in which the at least one performer is capable of performing the habitual action, notification information addressed to the performer, the existence of which is determined, is generated on the basis of the habitual information.

A program according to an embodiment causes a computer to execute the information processing method above.

### Advantageous Effects of Invention

As described above, in accordance with the present technology, it is possible to realize highly convenient information processing apparatus and information processing method and a program therefor.

It should be noted that the effect described herein are not necessarily limitative and may be any of effects described in the present disclosure.

### BRIEF DESCRIPTION OF DRAWINGS

FIG. 1 is a block diagram showing a configuration of a system according to an embodiment of the present technology.

FIG. 2 is an example of data indicating a user's action history.

FIG. 3 is a table showing an example of habitual information.

FIG. 4 is a flowchart showing an operation of recording a habitual action by a server.

FIG. 5 is a flowchart showing an operation of a notification including notification information generation processing mainly by a server.

FIGS. 6A to 6C show terminal devices that make notifications and notification modes using them.

### MODE(S) FOR CARRYING OUT THE INVENTION

Hereinafter, an embodiment according to the present technology will be described with reference to the drawings.

1. Configuration of System

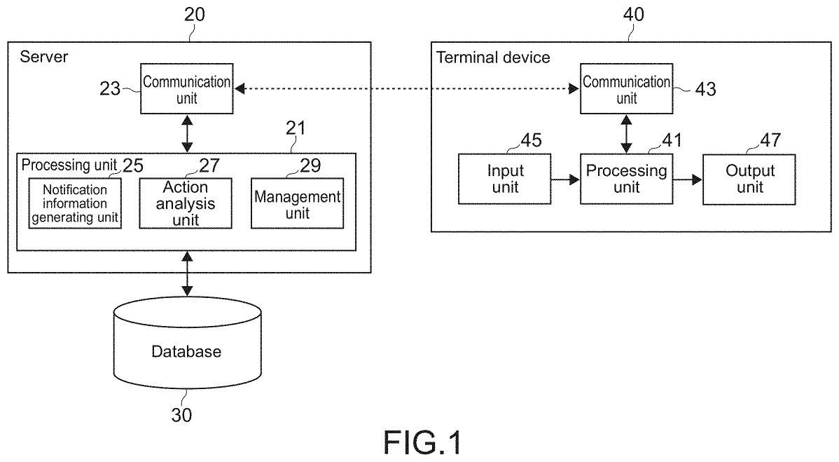

FIG. 1 is a block diagram showing a configuration of a system according to an embodiment of the present technology. This system includes a server 20, a database 30, and a terminal device 40. The server 20 primarily functions as an “information processing apparatus”.

The server 20 includes a processing unit 21 and a communication unit 23. The processing unit 21 includes a notification information generating unit 25, an action analysis unit (analysis unit) 27, and a management unit 29 and details of them will be described later. The communication unit 23 typically utilizes Internet protocol (IP) for communication with the communication unit 43 of the terminal device 40.

The terminal device 40 is a device utilized as Internet of things (IoT). The terminal device 40 is typically a smart speaker for example and can include a projector, various home appliances, a domestic surveillance camera, a personal computer (PC), a smartphone, a tablet computer, and a wearable device. A smart speaker may have a function of the projector.

The terminal device 40 includes a processing unit 41, the above-mentioned communication unit 43, an input unit 45, and an output unit 47.

The input unit 45 includes for example a camera, a microphone, an operation unit, and the like. The operation unit is a device for the user to manually make an input operation, such as a physical button and a touch panel. In a case where the terminal device 40 is a portable device such as a smartphone, the input unit 45 includes a position sensor (e.g., global navigation satellite system (GNSS) sensor), a motion sensor (e.g., an acceleration sensor, a gyro sensor, a geomagnetic sensor, and the like), and various other sensors.

The input unit 45 also includes a module such as Wi-Fi, Bluetooth, and a mobile network. In this case, the input unit 45 functions as the communication unit 43 in some cases.

The terminal device 40 may include a sensor set on an object that is a target for a user's habitual action as the input unit 45. The habitual action is an action that the user habitually takes and can include dumping, checking things for a time schedule of a school, and the like for example. In a case of dumping, a mode on which a sensor is attached to a trash box as the input unit 45 and the sensor is wirelessly connected to the terminal device 40 or the trash box is integrated with the terminal device 40 for example can be exemplified.

Alternatively, in a case where the terminal device 40 is a smartphone or a tablet computer, the input unit 45 may be configured to load information from particular application software. In this case, the input unit 45 and the processing unit 41 integrally function. When the processing unit 41 receives a notification indicating that a certain action has been completed from application software for a schedule table for example (application for managing the schedule mainly in accordance with a user's manual operations), the processing unit 41 is capable of sending that information to the server 20. The action analysis unit 27 and the management unit 29 of the server 20 are capable of utilizing the received “complete” information.

The terminal device 40 may include a plurality of terminal devices 40. For example, in a case where the terminal device 40 is a stationary type such as a smart speaker and a projector, those may be respectively installed in each chamber and an entrance of a house. Alternatively, in a case where the terminal device 40 is a device possessed by an individual, such as a smartphone, a plurality of terminal devices 40 exists in a single household.

The output unit 47 includes a display, a speaker, an actuator, a light emitting diode (LED), and the like. The terminal device 40 includes an eccentric motor that generates vibration as the actuator in a case where the terminal device 40 is a portable terminal device 40 such as a smartphone for example.

The processing unit 41 is configured to send and receive information to/from the input unit 45, the output unit 47, and the communication unit 43 and perform processing necessary for realizing the present technology.

The processing unit 21 (41) includes configurations such as a CPU, a RAM, and a ROM as hardware. Programs necessary for operation of the processing unit 21 (41) have been stored in the ROM.

The action analysis unit 27 in the processing unit 21 of the server 20 has a function of analyzing a user's action and analyzes whether or not the action is a habitual action. Further, the action analysis unit 27 has a function of analyzing whether at least one performer of the plurality of performers exists in a range in which the at least one performer is capable of performing the habitual action (performable range) on the basis of the information about the plurality of performers capable of performing the habitual action. Specifically, the server 20 receives information about the user's action which has been input via the input unit 45 of the terminal device 40 and the action analysis unit 27 analyzes the information. For the analysis, technologies such as image analysis and audio analysis are used.

During operation (to be described later) of the system based on the habitual information, whether or not the performer exists in the range in which the performer is capable of performing the habitual action is determined by mainly utilizing the camera of the input unit 45. It may be determined by utilizing a position sensor, a motion sensor, Wi-Fi, Bluetooth, a module of a mobile network, and the like in a composite manner other than the camera.

For example, in such a manner that the input unit 45 includes a device capable of sensing infrared rays as the camera or the other sensor, the analysis accuracy of the action analysis unit 27 is further enhanced.

The action analysis unit 27 is capable of distinguishing a user from other users by analyzing an image of the user obtained by the camera. Various image recognition technologies such as facial recognition, recognition of body proportion or height, and age estimation can be applied as that analysis technology.

In order to enhance the analysis accuracy (recognition accuracy) of the action analysis unit 27, the user may manually register user information such as a face image, the height, the body proportion, the age of the user in the server 20 as initial settings before the operation of the system starts. That is, the server 20 may obtain user image information input by a user's operation on the terminal device 40 and store the user image information in the database 30.

The management unit 29 primarily has a function of managing habitual information including the description of the habitual action. That habitual information is stored in the database 30 for example. The database 30 may be provided integrated with the server 20, that is, as a storage device incorporated in the server 20.

The notification information generating unit 25 has a function of generating notification information on the basis of the habitual information including the description of the habitual action. The notification information generated by the notification information generating unit 25 is sent to the terminal device 40 and the terminal device 40 notifies the user on the basis of that notification information.

2. Recording Management of User's Action

The management unit 29 of the server 20 generates the habitual information through machine learning by recording a history of the action analyzed by the action analysis unit 27 in the database 30 at a necessary time. It should be noted that the server 20 is capable of utilizing various well-known learning algorithms such as Bayes' theorem, clustering, a neural network, a support vector machine (SVM), genetic programming, and ensemble learning in a manner that depends on needs.

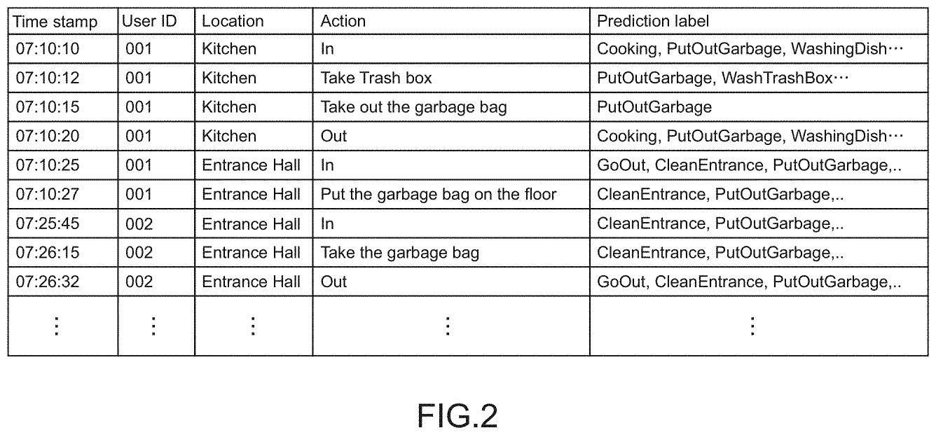

FIG. 2 is an example of data showing a user's action history. Action history data includes a time stamp, a user ID, a location, an action, and a prediction label.

The time stamp is a time at which the user starts the action. The user ID is identification information of the user.

The location is a location where the action occurs. The location where the action occurs can be typically detected by the camera serving as the input unit 45. Alternatively, it can be detected by utilizing a position sensor, a motion sensor, Wi-Fi, Bluetooth, a module of a mobile network, and the like in a composite manner other than the camera.

The prediction label indicates predicted purpose and candidates of the action. One of prediction labels corresponds to the habitual action in some cases.

A data example of the action history will be described. For example, one or more the terminal device 40 detect “a user (ID-001) entering a kitchen, taking a trash box, taking garbage (garbage bag) out of the trash box, bringing the garbage bag outside the kitchen, and putting the garbage on the floor of the entrance for 17 seconds from 7:10:10 a.m. to 7:10:27 a.m.” The action analysis unit 27 of the server 20 records a plurality of such action elements (in this example, a sequence of six action elements) as the action history in the database 30.

In addition, “a user (ID-002) different from ID-001 coming to the entrance, picking up that garbage, and exiting the entrance (going outside) for 47 seconds from 7:25:45 a.m. to 7:26:32 a.m.” is detected. The action analysis unit 27 records the plurality of such action elements (in this example, a sequence of three action elements) as the action history in the database 30.

Thereafter, in a case where the user ID-001 is further detected (may be detected when performing an action other than dumping), the user is recognized as the user ID-001 (e.g., “Mother”) in accordance with technologies such as facial recognition and recognition of body proportion or height as described above. The same applies to the user ID-002. Alternatively, as described above, the user manually registers an ID in initial setting, the recognition accuracy of the user after operation of the system starts is enhanced.

3. Recording Management of Habitual Action

The management unit 29 is configured to manage information including the descriptions of the action performed by the user a predetermined number of times that are two or more times for example as the habitual information. The predetermined number of times can be for example two to five times. In this case, there are two cases: a case where the number of times of actions performed by a single user is the predetermined number of times; and a case where the number of times of those actions of a plurality of users is the predetermined number of times.

When a certain action is performed the predetermined number of times, the management unit 29 may inquire the user of whether the action may be recorded as the habitual action in the habitual information. At this time, when the user allows it, the management unit 29 records the habitual action in the habitual information.

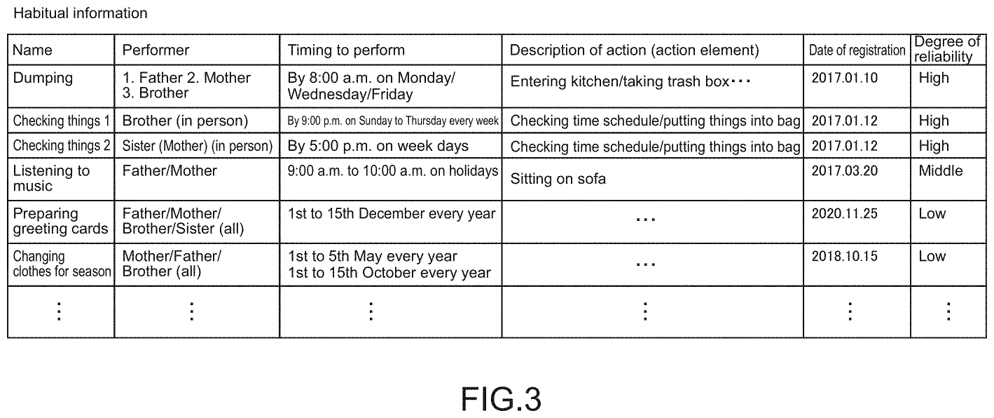

FIG. 3 is a table showing an example of the habitual information. The habitual information is recorded associated with the respective items such as “name (of habitual action)”, “performer”, “timing to perform”, “action element” (description of habitual action), “date of registration” (update date), and “degree of reliability”. Basically, the server 20 generates and updates this habitual information through learning. The user may manually set some or all pieces of habitual information and edit and update them.

The performer includes (the name, nickname, or the like of) one or more users. As described above, the management unit 29 records the predetermined number of times of actions performed by the user and registers it as the habitual information. One or more users at this time are the performers.

The numerical values of the performers indicate priorities. The priorities are set in order, provided that “1” is set to a person who has performed the habitual action a largest number of times. Alternatively, the user may manually set the priorities. The notification information generating unit 25 basically selects a target of the notification in an order that depends on the set priorities. Regarding items without the numerical values of the performers, it indicates that the priorities are not set for them.

The priorities are set in two or more steps. Even in a case where three or more performers have been registered, three or more priorities do not necessarily need to be set. For example, in a case where the priorities are set in two step and three performers have been registered, a higher priority “1” is set to a single person and a lower priority “2” is set to other two people for example.

The timing to perform indicates a timing at which the habitual action is scheduled to be performed (e.g., a timing to start performing). The management unit 29 generates a timing to perform on the basis of the time stamp of the action history data shown in FIG. 2.

The description of the action represents the above-mentioned action element. Although it will be also described later, in a case where a plurality of action elements is set, the action analysis unit 27 determines whether or not the action is the habitual action on the basis of the co-occurrence rate of the plurality of action elements.

The entire range inside a house, a location where the habitual action should be performed, or a predetermined range including the location (e.g., a chamber adjacent to the location, an entire range of a floor including the location, etc.) for example can be set as the above-mentioned performable range. It should be noted that a toilet, a bathroom and the like may be set as those that depart from the performable range. The action analysis unit 27 is capable of setting the performable range though learning on the basis of the action history data. In this case, the performable range may be a range in which all the plurality of action elements is performed or may be a region in which a last action element of those action elements is performed for example.

The performable range may be manually set by the user.

The date of registration is a date on which the action was recorded as the habitual action or updated.

The degree of reliability is a degree of reliability to recognition of the habitual action particularly in a case where the server 20 generates habitual information through learning. As a matter of course, the user may manually set this degree of reliability. Although evaluation of the degree of reliability is set as “high”, “middle”, or “low” in this table, numerical values and other notations may be used as a matter of course.

For example, the notification information generating unit 25 is capable of generating the notification information such that as the habitual action has a higher degree of reliability, it is more certainly performed. Specifically, as the habitual action has a higher degree of reliability, the notification information generating unit 25 increases the number of times of notifications or increases the level of the notification for example. The level of the notification is for example the sound volume or the level of such expressions in a case of audio notification and is the size of characters, signs, and figures displayed on the display or the level of such expressions in a case of display-based notification. Alternatively, a larger number of steps of “stepwise notification” to be described later may be used for the habitual action having a higher degree of reliability. In this manner, various notification modes depending on the degree of reliability can be achieved.

As described above, the server 20 is basically capable of managing the habitual information through learning, and thus the time and effort for the user to voluntarily register the habitual action can be saved in that case.

4. Operation of System

4.1) Operation of Recording Habitual Action

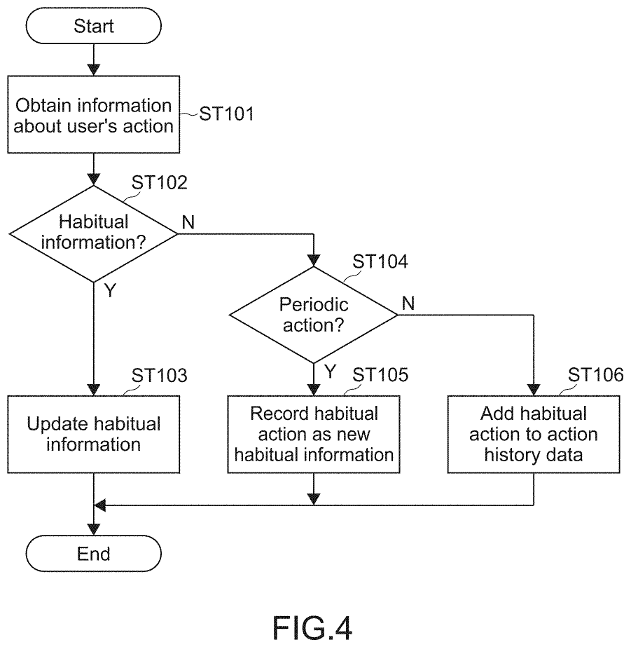

FIG. 4 is a flowchart showing an operation of recording the habitual action by the server 20. The recording of the habitual action is favorably started after a certain amount of action history data described above is accumulated (after a predetermined amount of data is accumulated or after predetermined days elapses for example).

The action analysis unit 27 obtains information about a user's current action via the input unit 45 of the terminal device 40 (Step (hereinafter, referred to as ST) 101) and generates or updates the habitual information by analyzing that information in ST102 and the steps after ST102. Specifically, the server 20 operates as follows.

The action analysis unit 27 determines whether or not the user's action is the habitual action on the basis of the habitual information shown in FIG. 3 (ST102). Specifically, in a case where that the user's action corresponds to (is the same as) the description of the habitual action in the habitual information, the action analysis unit 27 determines that the user's action is the habitual action. Here, the action analysis unit 27 is capable of determining whether or not the user's action is the habitual action on the basis of whether or not the user's action includes a plurality of action elements recorded as the action elements, i.e., whether or not the co-occurrence rate of those action elements reaches a threshold.

The threshold of the co-occurrence rate is favorably set to 100%, though not limited thereto. As the threshold becomes higher, the determination accuracy becomes higher. The user may be able to set the threshold.

Besides the co-occurrence rate, in a case where the plurality of action elements is temporally continuous, the action analysis unit 27 may determine that it is the habitual action. Accordingly, the determination accuracy can be further enhanced.

In a case where it is determined that the user's action is the habitual action, the management unit 29 records the habitual action in the habitual information and updates it (ST103). In ST103, the date of registration is updated for example.

Further, in ST103, a new user is recorded in some cases. In this case, the new user is recorded because the new user has performed the action corresponding to the habitual action multiple times in the past and the fact has been recorded in the action history data. Alternatively, in a case where another user has performed the same action as the user's action performed multiple times in the past, the other user may be registered as a new user. Further, also in a case where a new user has partly performed the habitual action, this user may also be registered as the new user of the habitual action.

In ST102, in a case where it is determined that the user's action is not the habitual action, the action analysis unit 27 determines whether or not it is the periodic action on the basis of the action history data shown in FIG. 2 (ST104). That is, in a case where the action has been recorded in the action history data a predetermined number of times or more, the action analysis unit 27 determines that it is the habitual action and the management unit 29 additionally records the habitual action as part of the habitual information (ST105). In a case where it is not the periodic action, the action is additionally recorded as the action history data (ST106).

4.2) Operation of Notification

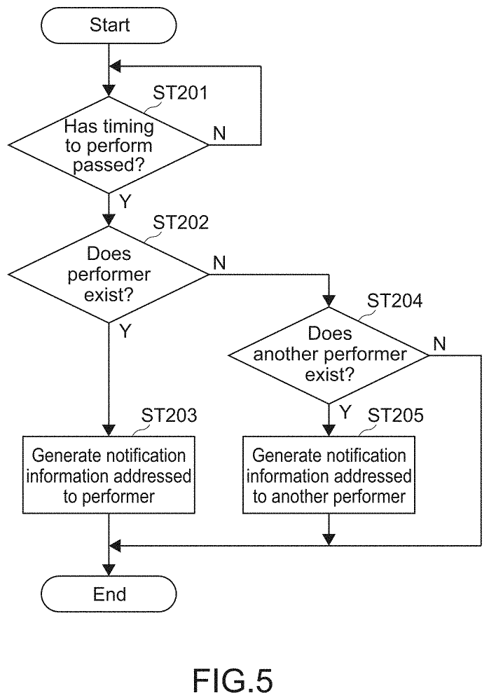

FIG. 5 is a flowchart showing an operation of the notification including generation processing of the notification information mainly by the server 20. The processing unit 21 refers to the habitual information and determines whether or not the performer has not performed the habitual action yet and a time as the timing to perform has passed (ST201). In a case where the time, the processing proceeds to ST202.

In a case where a time duration is set as the timing to perform, the processing unit 21 is capable of setting an arbitrary time (may be plural) in the time duration for example as reference time for notification. As an example, at least one time of the start and end in the time duration can be set as the reference time. Alternatively, a middle time in the time duration can be set as the reference time.

The action analysis unit 27 analyzes whether the performer exists in the performable range, i.e., determines whether or not the performer exists on the basis of the habitual information shown in FIG. 3 (ST202). Here, in a case where a plurality of users is registered as performers, whether or not the performer exists is determined in accordance with the set priorities.

For example, in a case where a performer corresponding to a highest priority exists in the performable range, the notification information generating unit 25 generates notification information to the performer, the notification information indicating that the timing to perform, here, a scheduled time to perform has passed (ST203). Then, the server 20 sends this notification information to the performer via the terminal device 40 (makes notification). This terminal device 40 is a speaker located within a range in which the performer can hear its sound or a smartphone or the like possessed by the performer.

In a case where the performer corresponding to the highest priority does not exist in the performable range, the action analysis unit 27 determines whether or not another performer corresponding to a second highest priority (in a case where the priorities are two steps, a lower priority) exists in the performable range (ST204). The server 20 generates notification information to the other performer as in the processing of ST203, the notification information indicating that the scheduled time to perform in the habitual information has passed (ST205), and sends the notification information to the performer via the terminal device 40 (makes notification).

In a case where there are no corresponding performers that should be detected by the terminal device 40 exist (No in ST204), the notification information generating unit 25 does not generate notification information (does not make notification). Alternatively, the notification information generating unit 25 may generate notification information indicating that the current habitual action has not been performed.

In a case where the priority has not been set to the corresponding performer, the action analysis unit 27 is capable of analyzing whether the user exists in the performable range in order of registration of users (time sequence order of registration) or at random, not in accordance with the priorities. In a case where the server 20 cannot find any user, the server 20 may display the notification information (e.g., the schedule table, etc.) or other information at a position at which those should be constantly displayed. Alternatively, in a case where the server 20 cannot find any user, the server 20 may send the notification information or other information to (a terminal device such as a smartphone of) a remote user.

In a case where a first performer does not exist, the notification information generating unit 25 may generate notification information including information (ID, name, nickname, or the like) of the first performer as notification information addressed to a second performer who has been selected as a performing target after the first performer. Accordingly, the second performer can know who the first performer was. Alternatively, the notification information generating unit 25 may generate the notification information addressed to the second performer, the notification information including a reason why the first performer is currently at another location for example.

For example, the first performer is a performer to which a first priority has been set and the second performer is a performer to which a second priority lower than the first priority has been set.

In a case where three or more steps for the priorities of the performers are set in the habitual information, determination (ST202 or 204) as to whether or not the performer exists may be made three or more times.

In a case where the time duration has been set as the timing to perform as described above, the processing unit 21 only needs to perform processing as follows. That is, the processing unit 21 only needs to determine whether or not the current time is in the time duration (the current time is in the predetermined time duration including the reference time) in ST201.

As shown in FIG. 3, in a case where the habitual action is “Checking things 1” or the like, “in person” is set in the habitual information as a performer condition. In a case where the person in question (here, “Brother”) does not exist in the performable range (No in ST202), another performer is not searched for, the operation of the system ends as in a case of No in ST204.

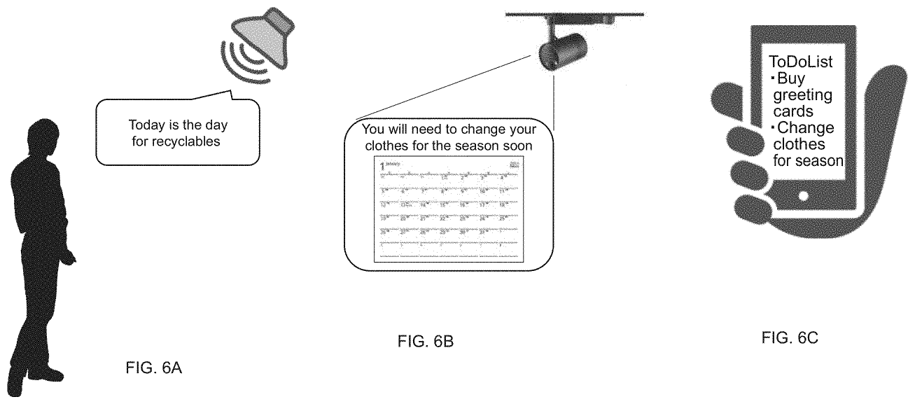

FIGS. 6A to 6C show the terminal device 40 that makes notifications and notification modes using them.

FIG. 6A shows an example in which the speaker outputs the speech “Today is the day for recyclables”. FIG. 6B shows an example in which the projector displays an image saying “You will need to change your clothes for the season soon” with a calendar that is the schedule table. It is assumed that the server 20 has the schedule table in advance and has a function of cooperating with the schedule table of the terminal device 40 (e.g., a smartphone possessed by each user). FIG. 6C shows an example in which the smartphone is automatically added to “Buy greeting cards” and “Change clothes for season” in the form of a ToDo list.

In a case where that the server 20 determines that the performer does not exist as a result of processing by the action analysis unit 27 as described above, a performing unit is capable of generating notification information regarding the habitual action to another person that can be the performer. Thus, even if one performer cannot perform the habitual action, it is possible to request another performer to perform it. Therefore, the convenience is enhanced.

Further, this system is capable of making a notification that prompts the target to perform the habitual action and the performer can prevent from forgetting the habitual action on the basis of it.

In addition, not only a plurality of action elements performed by a single user but also a plurality of action elements performed by a plurality of users together are recorded as the habitual actions, for example. For example, “dumping” as the habitual information includes two action elements of Mother (ID-001) and Father (ID-002) on the basis of the action history data (see FIG. 2). In this manner, the server 20 is capable of extracting the habitual action on the basis of action histories of a plurality of people also for an action that typically cannot be a habitual action only by a single person.

5. Mode of Stepwise Notification

Hereinafter, a mode of stepwise notification performed by the server 20 or the terminal device 40 will be described.

5.1) Example Using Identical Modal

5.1.1) Example 1

In a case of the audio notification, the notification information generating unit 25 is capable of generating notification information so as to stepwisely change audio contents. In a specific example, stepwise notifications for example “Today is the day for combustible garbage” as a first step, “It is about time to bring the garbage” as a second step, and “Hurry up and bring the garbage!” as a third step can be provided such that the urgent impression gradually increases as the timing to perform approaches.

5.1.2) Example 2

In a case of the audio notification, the notification information generating unit 25 is capable of generating notification information so as to make changes to stepwisely increase the sound volume. As a specific example, there is a mode to output a warning sound immediately after the message “Today is the day for combustible garbage”. In this case, as the timing to perform approaches, a weak warning sound “pop” in a first step and a stronger warning sounds “bleep” and the like in a second step and the subsequent steps can be output in order. As a matter of course, warning sounds in three or more steps may be provided.

Alternatively, it is also possible to stepwisely change the notification sound volume of the main message “Today is the day for combustible garbage”.

5.1.3) Example 3

In a case of the display-based notification, the notification information generating unit 25 is capable of generating notification information to stepwisely change the display. As a specific example, as the timing to perform approaches, “Today is the day for combustible garbage” can be displayed on a calendar displayed on the display as the first step and only the message “Today is the day for combustible garbage” can be displayed in color as the second step. In the second step or the next third step, only the message “Today is the day for combustible garbage” may be displayed in a blinking manner. Alternatively, the display may be performed to stepwisely change the size of those characters.

5.2) Example Using Different Modals

The notification information generating unit 25 is capable of generating notification information to provide only a display-based notification in a first step and add audio notification to the display-based notification in a second step.

5.3) Example to Stepwisely Change Location, Terminal Device, and/or Performer

The notification information generating unit 25 is capable of generating notification information so as to stepwisely change the location, the terminal device 40, and/or the performer (target) to be notified as the timing to perform approaches. As a specific example, a notification can be displayed on a calendar in a living room in a first step and the terminal device 40 in each chamber or the terminal device 40 in a location where each performer exists can be notified in a second step. In a third step, the terminal device 40 (e.g., a smartphone or a wearable device) possessed by each performer may be notified.

Alternatively, the notification information generating unit 25 is capable of generating notification information addressed to a performer having a first priority in a first step and is capable of generating notification information addressed to all performers in a second step. Alternatively, a change into performers having first and second priorities in the second step and a change into performers having first, second, and third priorities in the third step may be made.

6. Other Mode in Case Where Priorities of Performers Not Have Been Set

In the above description, in a case where the priorities have not been set to the corresponding performers, the action analysis unit 27 is capable of analyzing whether the user exists in the performable range in order of registration of users (time sequence order of registration) or at random, not in accordance with the priorities. However, the server 20 is also capable of searching for the performer as follows.

The case where the priority has not been set at the time of determination as to the performer (in ST202 shown in FIG. 5) includes the following case for example. It is a case where another performer is searched for in a case where only one performer has been registered as the habitual information and the single performer does not exist in the performable range in an initial step of accumulation of the action history data.

On this mode, the habitual information includes information about a “degree of difficulty” besides the respective items shown in FIG. 3. The degrees of difficulty are manually set by the user for each habitual action for example and indicate degrees of difficulty in two or more steps to perform the habitual action. For example, the degrees of difficulty may be set by using the age as a reference. For example, in two steps, “high” is set to users over 20 years old and “low” is set to users under 20 years old. As one item of the habitual information, instead of or in addition to the degrees of difficulty, the “category (of the habitual action)” may be set.

It should be noted that when recording the habitual action in the habitual information as described above, the management unit 29 may request the user to allow it and the user may set such degrees of difficulty and other items at that time.

For example, it is assumed that always “Mother” has performed “dumping at 8 o'clock on week days” and only “Mother” has been registered as the performer. Moreover, it is assumed that at the timing to perform, “Mother” does not stay at home at 8 o'clock on a week day for some reason. In this case, the action analysis unit 27 determines that “Mother” does not exist in the performing range (No in ST202). In a case where the action analysis unit 27 detects “Father” and “Brother” (elementary school student) in the performable range as performers other than “Mother” (see FIG. 3), the action analysis unit 27 selects “Father” on the basis of the degree of difficulty of the habitual information. It is because “Father” is over twenty years old. Therefore, the notification information generating unit 25 generates notification information addressed to “Father”.

For example, the description “Mother may forget to do dumping. Please do dumping instead of her” or the like can be exemplified as the notification information addressed to “Father”. This notification information is notification information including information about the first performer as described above.

Then, Father replies to the system “I got it. I will bring the garbage” and the server 20 is capable of recognizing this action as the action of “dumping” and recording the habitual information, considering “Father” as a performer having a second priority to “Mother” as the performer of the habitual action of “dumping”. Further, in this case, the notification information generating unit 25 generates notification information indicating “Father has dumped the garbage” addressed to the terminal device 40 (e.g., a smartphone or a wearable device) possessed by “Mother”.

The mode described above can also be applied to a case where the plurality of performers has been set from the initial step and their priorities have not been set as a matter of course.

7. Other Specific Cases

In view of the above-mentioned embodiment, other specific cases of “dumping” will be described below.

7.1) Specific Example 1

A specific example 1 shows an example in which a terminal device possessed by an individual primarily such as a smartphone is typically used as the terminal device 40 equipped with the input unit 45.

Every morning, “Mother” habitually checks the weather of a location near her home and a location where she goes on that day immediately after she wakes up. It is assumed that first appearing of Mother after 6 o'clock a.m. is set as a start action (first action element) of the habitual action. Although this start action is detected by the terminal device 40 (e.g., a smartphone equipped with a camera) possessed by Mother for example, it may be detected by another camera.

The terminal device 40 (e.g., the smartphone equipped with the camera) possessed by Mother refers to schedule information and Mother's work place and work days registered in the schedule table, obtains weather information at the work place and the like from the server 20, and displays a screen including such information on a display.

In a case where it is determined that Mother does not watch the display during such display and the server 20 obtains this information, the terminal device 40 does not update the habitual information (or the action history). When Mother visually recognizes the terminal device 40 at a next time, the terminal device 40 displays the screen including the weather information on the display. When Mother carefully views that the contents of the display or makes an audio input by herself, “Thank you”, the terminal device 40 determines that Mother has checked the screen and the habitual action has been completed.

7.2) Specific Example 2

In a holiday morning, “Father” and “Mother” habitually sits on a sofa and listen to music. As shown in FIG. 3, “Father” and “Mother” have been registered as the performers in the habitual information. In this case, the performer is under an “OR” condition and the priorities have not been set. It is assumed that the fact that either one of those two people sits on a sofa in a holiday morning is set as a start action.

When the start action occurs, the server 20 makes a notification, for example, “Do you want to listen to music?” via the terminal device 40. The terminal device 40 in this case is for example a smart speaker installed in a room where the sofa is placed or a smartphone or the like possessed by “Father” or “Mother”. It is assumed that the server 20 analyzes that it is only Mother that is the user (performer) existing in a range in which the user (performer) can hear music through the smart speaker, the speaker installed in the smartphone, or another speaker. In this case, the server 20 refers to the action history data, extracts, from the database 30, a playlist including music that only Mother has heard in the past and sends one command to at least one of those speakers in accordance with the playlist.

In this manner, in this specific example 2, the action history data and data necessary for performing the habitual action are associated with each other and the database 30 stores the associated information. When performing the habitual action, the server 20 is capable of utilizing the data necessary for performing the habitual action.

7.3) Specific Example 3

“Brother” (elementary school student) habitually checks things to bring to a school by 8:50 p.m. on a day before a day on which he goes to the school (Checking things). As shown in FIG. 3, “Checking things” is set as the habitual action in the habitual information. In the specific example 3, since “in person” has been set in the habitual information as the performer condition as described above, the performer is only him.

In a case where Brother has not checked the things even after 8:50 p.m. (ST201) and Brother exists in the performable range (Yes in ST202), the server 20 generates notification information for displaying an icon indicating “Checking things, 00 (Brother's name)” and the terminal device 40 displays the icon. This terminal device 40 is a projector or a display for example.

In a case where the things has not been checked by 8:55 p.m., the server 20 generates audio information based on a speech saying “Do you have all the things, oo?” and image information about a list of the things as the notification information and the terminal device 40 presents the notification information. Regarding a day for which no particular things have been set, the message “You don't need particular things today, oo (son's name)” may be presented at the timing to perform.

7.4) Specific Example 4

On the basis of schedule tables for all the family members “Father”, “Mother”, “Brother”, and “Sister” for several years in the past, writing greeting cards in the middle of December (December) has been automatically registered in the habitual information as the habitual action (see “Preparing greeting cards” in FIG. 3). In a case where a cycle for the habitual action (one year in this specific example) is long, a time duration including a reference time (December 15th) as the timing to perform is set to be long. The start time for the timing to perform the habitual action once a year has been set before the reference time (December 1st). Therefore, the server 20 generates notification information saying “You will need to write greeting cards” in the beginning of December when all the family members gather for example and the terminal device 40 presents it.

In the specific example 4, since the time duration of the timing to perform is long, the notification is made when all the family members exist together in the performable range as the performers.

7.5) Specific Example 5

“Mother” or “Father” habitually writes a schedule to receive the commodity in a schedule table for staying at home during a commodity delivery time after online shopping. In this case, the fact that terminating online shopping has been recorded in the action history data as the start action of the action element. The server 20 has recorded an action to the action of writing the commodity-receiving schedule from the start action as the habitual information. In this case, for example, the server 20 is capable of considering a screen transfer to terminate online shopping, the response of the server 20 at the online shop “We have accepted your order for this commodity”, a Mother's or Father's speech of “That is OK”, or the like as an order completion action. After the habitual information is generated, the server 20 adds date and time for reception of the ordered commodity in the schedule table.

In the specific example 5, the server 20 is capable of recording one of the plurality of action elements recorded in the action history data, here, an element that has been manually by the user, the last “writing a schedule in the schedule table” as the habitual information. After that, the server 20 is capable of automatically performing one of those elements.

8. Modified Examples

The present technology is not limited to the above-mentioned embodiment, and various other embodiments can be made.

At least one of the processes or all the processes performed by the server 20 may be performed by one or more terminal devices 40. In a case where the terminal device 40 performs main processing to be performed by the server 20, the terminal device 40 functions as the “information processing apparatus”.

In the example of the processing shown in FIG. 5, the notification information generating unit 25 generates the information indicating that the scheduled time to perform in the habitual information has passed as the notification information, though not limited thereto. The notification information generating unit 25 may generate information indicating that the timing to perform will pass a predetermined time later from the current time, for example, “It is about time to . . . ” as the notification information a predetermined time before the timing to perform for example. In this case, it is unnecessary to set the time duration as the timing to perform.

At least two feature parts of the feature parts of the above-mentioned embodiment can also be combined.

It should be noted that the present technology can also take configurations as follows.
(1) An information processing apparatus, including:

an analysis unit configured to analyze, on the basis of information about a plurality of performers capable of performing a habitual action in habitual information including descriptions of habitual actions of a plurality of users, whether at least one performer of the plurality of performers exists in a range in which the at least one performer is capable of performing the habitual action; and

a notification information generating unit configured to generate, in a case where the analysis unit determines that the at least one performer exists in the range in which the at least one performer is capable of performing the habitual action, notification information addressed to the performer, the existence of which is determined, on the basis of the habitual information.
(2) The information processing apparatus according to (1), in which

the notification information generating unit is configured to generate the notification information on the basis of a timing at which the habitual action is scheduled to be performed, the timing being included in the habitual information.
(3) The information processing apparatus according to (2), in which

the notification information generating unit is configured to generate the notification information by setting at least one performer of the plurality of performers to be a target in a case where the analysis unit determines that at least one performer of the plurality of performers exists and a current time has passed the timing at which the habitual action is scheduled to be performed.
(4) The information processing apparatus according to (2) or (3), in which

the notification information generating unit is configured to generate the notification information by setting at least one performer of the plurality of performers to be a target in a case where the analysis unit determines that the at least one performer of the plurality of performers exists and a current time is in a predetermined time duration including a reference time as the timing at which the habitual action is scheduled to be performed.
(5) The information processing apparatus according to any one of (1) to (4), in which

the habitual information includes priorities respectively given to the plurality of performers.
(6) The information processing apparatus according to (5), in which

the notification information generating unit is configured to select a target of the notification in an order that depends on the priorities.
(7) The information processing apparatus according to any one of (1) to (6), in which

the notification information generating unit is configured to generate the notification information so as to make notifications stepwisely.
(8) The information processing apparatus according to (7), in which

the notification information generating unit is configured to generate the notification information so as to stepwisely make notifications as the timing at which the habitual action is scheduled to be performed approaches, the timing being included in the habitual information.
(9) The information processing apparatus according to any one of (1) to (8), further including

a management unit configured to manage information in which the plurality of performers, the timing at which the habitual actions are scheduled to be performed, and the descriptions of the habitual actions are associated with each other, as the habitual information.
(10) The information processing apparatus according to any one of (1) to (9), in which

the analysis unit is configured to further analyze whether or not an action of the user is a habitual action corresponding to one of the descriptions of the habitual actions in the stored habitual information.
(11) The information processing apparatus according to (10), in which

the management unit is configured to manage information including the description of the action performed by the user a predetermined number of times as the habitual information, the predetermined number of times being two or more times.
(12) The information processing apparatus according to (10) or (11), in which

the analysis unit is configured to determine whether or not it is the habitual action on the basis of a co-occurrence rate of a plurality of action elements.
(13) The information processing apparatus according to (12), in which

the analysis unit is configured to determine that it is the habitual action in a case where the plurality of action elements is temporally continuous.
(14) The information processing apparatus according to any one of (1) to (13), in which

the notification information generating unit is configured to generate, in a case where the analysis unit determines that a first performer of the plurality of performers does not exist in a range in which the first performer is capable of performing the habitual action, notification information including information about the first performer as notification information addressed to the second performer.
(15) The information processing apparatus according to any one of (1) to (14), in which

the habitual information includes a degree of reliability indicating reliability of recognition of the habitual action.
(16) An information processing method, including:

analyzing, on the basis of information about a plurality of performers capable of performing a habitual action in habitual information including descriptions of habitual actions of a plurality of users, whether at least one performer of the plurality of performers exists in a range in which the at least one performer is capable of performing the habitual action; and

generating, in a case where the analysis unit determines that the at least one performer exists in the range in which the at least one performer is capable of performing the habitual action, notification information addressed to the performer, the existence of which is determined, on the basis of the habitual information.
(17) A program that causes a computer to execute:

analyzing, on the basis of information about a plurality of performers capable of performing a habitual action in habitual information including descriptions of habitual actions of a plurality of users, whether at least one performer of the plurality of performers exists in a range in which the at least one performer is capable of performing the habitual action; and

generating, in a case where the analysis unit determines that the at least one performer exists in the range in which the at least one performer is capable of performing the habitual action, notification information addressed to the performer, the existence of which is determined, on the basis of the habitual information.

### REFERENCE SIGNS LIST

20 server
21 processing unit
23 communication unit
25 notification information generating unit
27 action analysis unit
29 management unit
30 database
40 terminal device
41 processing unit
43 communication unit
45 input unit
47 output unit

1. An information processing apparatus, comprising:
an analysis unit configured to analyze, on a basis of information about a plurality of performers capable of performing a habitual action in habitual information including descriptions of habitual actions of a plurality of users, whether at least one performer of the plurality of performers exists in a range in which the at least one performer is capable of performing the habitual action; and
a notification information generating unit configured to generate, in a case where the analysis unit determines that the at least one performer exists in the range in which the at least one performer is capable of performing the habitual action, notification information addressed to the performer, the existence of which is determined, on a basis of the habitual information.

2. The information processing apparatus according to claim 1, wherein
the notification information generating unit is configured to generate the notification information on a basis of a timing at which the habitual action is scheduled to be performed, the timing being included in the habitual information.

3. The information processing apparatus according to claim 2, wherein
the notification information generating unit is configured to generate the notification information by setting at least one performer of the plurality of performers to be a target in a case where the analysis unit determines that at least one performer of the plurality of performers exists and a current time has passed the timing at which the habitual action is scheduled to be performed.

4. The information processing apparatus according to claim 2, wherein
the notification information generating unit is configured to generate the notification information by setting at least one performer of the plurality of performers to be a target in a case where the analysis unit determines that the at least one performer of the plurality of performers exists and a current time is in a predetermined time duration including a reference time as the timing at which the habitual action is scheduled to be performed.

5. The information processing apparatus according to claim 1, wherein
the habitual information includes priorities respectively given to the plurality of performers.

6. The information processing apparatus according to claim 5, wherein
the notification information generating unit is configured to select a target of the notification in an order that depends on the priorities.

7. The information processing apparatus according to claim 1, wherein
the notification information generating unit is configured to generate the notification information so as to make notifications stepwisely.

8. The information processing apparatus according to claim 7, wherein
the notification information generating unit is configured to generate the notification information so as to stepwisely make notifications as the timing at which the habitual action is scheduled to be performed approaches, the timing being included in the habitual information.

9. The information processing apparatus according to claim 1, further comprising
a management unit configured to manage information in which the plurality of performers, the timing at which the habitual actions are scheduled to be performed, and the descriptions of the habitual actions are associated with each other, as the habitual information.

10 The information processing apparatus according to claim 1, wherein
the analysis unit is configured to further analyze whether or not an action of the user is a habitual action corresponding to one of the descriptions of the habitual actions in the stored habitual information.

11. The information processing apparatus according to claim 10, wherein
the management unit is configured to manage information including the description of the action performed by the user a predetermined number of times as the habitual information, the predetermined number of times being two or more times.

12. The information processing apparatus according to claim 10, wherein
the analysis unit is configured to determine whether or not it is the habitual action on a basis of a co-occurrence rate of a plurality of action elements.

13. The information processing apparatus according to claim 12, wherein
the analysis unit is configured to determine that it is the habitual action in a case where the plurality of action elements is temporally continuous.

14. The information processing apparatus according to claim 1, wherein
the notification information generating unit is configured to generate, in a case where the analysis unit determines that a first performer of the plurality of performers does not exist in a range in which the first performer is capable of performing the habitual action, notification information including information about the first performer as notification information addressed to the second performer.

15. The information processing apparatus according to claim 1, wherein
the habitual information includes a degree of reliability indicating reliability of recognition of the habitual action.

16. An information processing method, comprising:
analyzing, on a basis of information about a plurality of performers capable of performing a habitual action in habitual information including descriptions of habitual actions of a plurality of users, whether at least one performer of the plurality of performers exists in a range in which the at least one performer is capable of performing the habitual action; and
generating, in a case where the analysis unit determines that the at least one performer exists in the range in which the at least one performer is capable of performing the habitual action, notification information addressed to the performer, the existence of which is determined, on a basis of the habitual information.

17. A program that causes a computer to execute:
analyzing, on a basis of information about a plurality of performers capable of performing a habitual action in habitual information including descriptions of habitual actions of a plurality of users, whether at least one performer of the plurality of performers exists in a range in which the at least one performer is capable of performing the habitual action; and
generating, in a case where the analysis unit determines that the at least one performer exists in the range in which the at least one performer is capable of performing the habitual action, notification information addressed to the performer, the existence of which is determined, on a basis of the habitual information.
